(19) United States
(12) Patent Application Publication
(10) Pub. No.: US 2009/0294384 A1
(43) Pub. Date: Dec. 3, 2009

(54) REMOVAL OF BITUMEN FROM SLURRY USING A SCAVENGING GAS

(76) Inventor: Jan Kruyer, Alberta (CA)

Correspondence Address: THORPE NORTH & WESTERN, LLP., P.O. Box 1219, SANDY, UT, 84091-1219, US

(21) Appl. No.: 12/132,165

(22) Filed: Jun. 3, 2008

(51) Int. Cl. C02F 1/24; C02F 1/38; C02F 103/10

(52) U.S. Cl. 210/788; 210/151

(57) ABSTRACT

A separating apparatus can be used for separating components of a fluid. The apparatus can include a substantially open cylindrical vessel and a helical confined conduit connected upstream of the cylindrical vessel. The open vessel can include an open vessel inlet configured to introduce a fluid tangentially into the open vessel. The helical confined conduit can be connected to the open vessel at the open vessel inlet. A series of gas nozzles can be used to introduce gas bubbles into the helical confined path and/or the open vessel which draw bitumen from an outer flow region to an inner flow region of the slurry. An overflow outlet and underflow outlet can be operatively attached to the open vessel for removal of the separated fluid components. Although a number of fluids can be effectively treated, de-sanding of bitumen slurries from oil sands can be readily achieved.

### RELATED APPLICATIONS

This application is related to U.S. patent application Ser. No. 11/940,099 entitled “Hydrocyclone and Associated Methods,” filed on Nov. 14, 2007 and to U.S. patent application Ser. No. 11/939,978 entitled “Sinusoidal Mixing and Shearing Apparatus and Associated Methods,” filed on Nov. 14, 2007 which are incorporated herein by reference.

### FIELD OF THE INVENTION

The present invention relates to devices and methods for hydraulically sorting of fluids after these have been processed by static mixing and/or shearing of fluids, or by other methods. Accordingly, the present invention involves the fields of process engineering, chemistry, and chemical engineering.

### BACKGROUND OF THE INVENTION

According to some estimates, oil sands, also known as tar sands or bituminous sands, may represent up to two-thirds of the world's petroleum. Oil sands resources are relatively untapped. Perhaps the largest reason for this is the difficulty of extracting bitumen from the sands. Mineable oil sand is found as an ore in the Fort McMurray region of Alberta, Canada, and elsewhere. This oil sand includes sand grains having viscous bitumen trapped between the grains. The bitumen can be liberated from the sand grains by slurrying the as-mined oil sand in water so that the bitumen flecks move into the aqueous phase for separation. For the past 40 years, bitumen in McMurray oil sand has been commercially recovered using the original Clark Hot Water Extraction process, along with a number of improvements. Karl Clark invented the original process at the University of Alberta and at the Alberta Research Council around 1930 and improved it for over 30 years before it was commercialized.

In general terms, the conventional hot water process involves mining oil sands by bucket wheel excavators or by draglines at a remote mine site. The mined oil sands are then conveyed, via conveyor belts, to a centrally located bitumen extraction plant. In some cases, the conveyance can be as long as several kilometers. Once at the bitumen extraction plant, the conveyed oil sands are conditioned. The conditioning process includes placing the oil sands in a conditioning tumbler along with steam, water, and caustic soda in an effort to disengage bitumen from the sand grains of the mined oil sands. Further, conditioning is intended to remove oversize material for later disposal. Conditioning forms a hot, aerated slurry for subsequent separation. The slurry can be diluted for additional processing, using hot water. The diluted slurry is then pumped into a primary separation vessel (PSV). The diluted hot slurry is then separated by flotation in the PSV. Separation produces three components: an aerated bitumen froth which rises to the top of the PSV; primary tailings, including water, sand, silt, and some residual bitumen, which settles to the bottom of the PSV; and a middlings stream of water, suspended clay, and suspended bitumen. The bitumen froth can be skimmed off as the primary bitumen product. The middlings stream can be pumped from the middle of the PSV to sub-aeration flotation cells to recover additional aerated bitumen froth, known as a secondary bitumen product. The primary tailings from the PSV, along with secondary tailings product from flotation cells are pumped to a tailings pond, usually adjacent to the extraction plant, for impounding. The tailings sand can be used to build dykes around the pond and to allow silt, clay, and residual bitumen to settle for a decade or more, thus forming non-compacting sludge layers at the bottom of the pond. Clarified water eventually rises to the top for reuse in the process. Additional details of the process are provided in the above-referenced patent application, U.S. patent application Ser. No. 11/940,099.

One such alternate method of oil sands extraction is the Kruyer Oleophilic Sieve process invented in 1975. Like the Clark Hot Water process, the Kruyer Oleophilic Sieve process originated at the Alberta Research Council and a number of Canadian and U.S. patents were granted to Kruyer as he privately developed the process for over 30 years. The first Canadian patent of the Kruyer process was assigned to the Alberta Research Council and, and all subsequent patents remain the property of Kruyer. Unlike the Clark process, which relies on flotation of bitumen froth, the Kruyer process uses a revolving apertured oleophilic wall and passes the oil sand slurry to the wall to allow hydrophilic solids and water to pass through the wall apertures whilst capturing bitumen and associated oleophilic solids by adherence to the surfaces of the revolving oleophilic wall. Along the revolving apertured oleophilic wall, there are one or more separation zones to remove hydrophilic solids and water and one or more recovery zones where the recovered bitumen and oleophilic solids are removed from the wall.

Attention is drawn to the fact that in the Hot Water Extraction process the term “conditioning” is used to describe a process wherein oil sands are gently mixed with controlled amounts water in such a manner as to entrain air in the slurry to eventually create a bitumen froth product from the separation. The Oleophilic Sieve process also produces a slurry when processing mined oil sands but does not “condition” it. Air or gas normally is not required in the Oleophilic Sieve process in large amounts. The Kruyer process was tested extensively and successfully implemented in a pilot plant with high grade mined oil sands (12 wt % bitumen), medium grade mined oil sands (10 wt % bitumen), low grade oil sands (6 wt % bitumen) and with sludge from commercial oil sands tailings ponds (down to 2% wt % bitumen), the latter at separation temperatures as low as 5° C. A large number of patents are on file for the Kruyer process in the Canadian and U.S. Patent Offices. These patents include: CA 2,033,742; CA 2,033,217; CA 1,334,584; CA 1,331,359; CA 1,144,498 and related U.S. Pat. No. 4,405,446; CA 1,141,319; CA 1,141,318; CA 1,132,473 and related U.S. Pat. No. 4,224,138; CA 1,288,058; CA 1,280,075; CA 1,269,064; CA 1,243,984 and related U.S. Pat. No. 4,511,461; CA 1,241,297; CA 1,167,792 and related U.S. Pat. No. 4,406,793; CA 1,162,899; CA 1,129,363 and related U.S. Pat. No. 4,236,995; and CA 1,085,760, as well as U.S. patent application Ser. No. 11/939,978, filed Nov. 14, 2007; Ser. No. 11/940,099, filed Nov. 14, 2007; Ser. No. 11/948,851, filed Nov. 30, 2007; and Ser. No. 11/948,816, filed Nov. 30, 2007.

While in a pilot plant, the Kruyer process has yielded higher bitumen recoveries, used lower separation temperatures, was more energy efficient, required less water, did not produce toxic tailings, used smaller equipment, and was more movable than the Clark process. There were a number of drawbacks, though, to the Kruyer process. One drawback to the Kruyer process is related to the art of scaling up. Scaling up a process from the pilot plant stage to a full size commercial plant normally uncovers certain engineering deficiencies of scale, which have resulted in several new patent applications, included in the listing above.

As such, improvements to methods and related equipment for recovery of bitumen from oil sands continue to be sought through ongoing research and development efforts.

### SUMMARY OF THE INVENTION

Accordingly, the present invention relates to the separation of mined oil sands or bitumen containing mixtures by an endless oleophilic belt formed by wrapping an oleophilic endless wire rope a plurality of times around two or more drums or rollers to form a multitude of sequential oleophilic wraps wherein hydrophilic materials including water and hydrophilic solids pass through the spaces or voids between said sequential wraps in a separation zone and oleophilic materials including bitumen and oleophilic solids are captured by the oleophilic wraps for subsequent removal in a recovery zone. Before mined oil sands can be separated, bitumen can be disengaged from the sand grains by a mixing and/or shearing action in the presence of a continuous water phase.

This present invention relates particularly to a hydrocyclone and a related method for separating components from a fluid or from an oil sand slurry after it has been processed in a pipe or pipeline sufficient to disengage at least a portion of bitumen from sand particles of the slurry. In one aspect, the hydrocyclone can be used to de-sand a slurry including bitumen and solid particulate such as gravel, sand, silt and clay. The hydrocyclone includes a helical confined path connected to and upstream of a substantially open cylindrical vessel. The connection from the helical confined conduit to the open vessel, or open vessel inlet, can be configured to, without substantial disturbance, introduce a fluid tangentially from the helical confined path into the open vessel. The hydrocyclone can further include an overflow outlet and an underflow outlet, both operatively attached to the open vessel. The underflow outlet can be attached at a location on the open vessel that is substantially opposite the helical confined path and open vessel inlet. The overflow outlet can be configured to terminate at one end at a vortex finder that is positioned in an interior of the open cylindrical vessel and has a substantially enclosed conduit from the vortex finder to an exterior of the open cylindrical vessel.

Likewise, a method for separating components from a fluid can include guiding the fluid along a helical path at high velocity to form a helically flowing fluid. The method can further include tangentially injecting the helically flowing fluid smoothly at high velocity into an open vessel to cause the fluid to rotate along a swirl path within the open vessel. The rotation along the swirl path of the fluid can be sufficient to produce an overflow and an underflow. A rinse fluid can be injected tangentially into at least one of the helical path and the swirl path. The underflow and the overflow can be removed from the open vessel. The rinse fluid generally includes or consists essentially of water, although other fluids or additives can be used.

Such hydrocyclone and methods can be used for a variety of applications, and specifically for de-sanding aqueous fluids containing bitumen. In a further embodiment, the fluid can include gravel, sand, fines, bitumen and water, and can produce an overflow primarily of bitumen, fines and water, while the underflow includes gravel and coarse sand.

Much of this was disclosed in the above-referenced patent application Ser. No. 11/940,099, which described the injection of wash water into a helical confined conduit or an open vessel in an effort to wash bitumen out of the outside flow regions of the helical confined conduit.

In the Clark process, air is added in the oil sand slurry preparation process to cause bitumen to rise to the top of separation vessels and this is not required for separation by the Kruyer process. However, when an oil sand slurry is prepared and transported in a pipe, and is then separated by a hydrocyclone into an underflow of coarse solids in water and an overflow of fine solids and bitumen in water, some of the bitumen will remain captured in the voids between the coarse particulates. Small bubbles of gas can be introduced in the outer flow path of the helical confined conduit and/or in the open vessel to scavenge for small trapped bitumen droplets and cause their adhesion to these gas bubbles to change the bulk density of the trapped bitumen and cause the bitumen droplets to move away from the outer flow path due to the centripetal forces acting on the fluid in this conduit or in the open vessel. The amount of gas required to scavenge for these trapped bitumen droplets is relatively small and in some cases this gas may be absorbed in the bulk of the slurry liquid after the scavenged bitumen droplets have moved away from the coarse solids and have joined the bulk of the fine solids and water on their way to the overflow of the hydrocyclone.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a plan top view of a hydrocyclone with a helical confined conduit in the form of a spiral, in accordance with an embodiment of the present invention. The flanges, although not required, are added to make it easier in the figure to follow the curve of the conduit.

FIG. 2 is a side view of the hydrocyclone of FIG. 1. In this case, the hydrocyclone uses an overflow that leaves from the top and an underflow that leaves from the bottom of the open vessel, in accordance with an embodiment of the present invention.

FIG. 3 is a sectional view of an outer curved wall of a helical confined conduit showing a nozzle mounted on and through this wall, in accordance with an embodiment of the present invention.

FIG. 4 is a schematic illustration of the contents of a helical confined conduit showing the coarse solids flowing along the outer curved wall and showing the effect of gas bubbles from a nozzle attaching to bitumen droplets and causing the density reduced bitumen droplets to move out of the voids between the coarse solids towards the opposite wall of the conduit due to centripetal force, in accordance with an embodiment of the present invention.

It will be understood that the above figures are simplified and are merely for illustrative purposes in furthering an understanding of the invention without in any way limiting any applications or aspects of the invention. Further, the figures are not drawn to scale, thus dimensions and other aspects may, and generally are, exaggerated or changed to make illustrations thereof clearer. Therefore, departure can be made from the specific dimensions and aspects shown in the figures in order to produce the hydrocyclone of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a pump” includes one or more of such pumps, reference to “an elbow” includes reference to one or more of such elbows, and reference to “injecting” includes reference to one or more of such actions.

Definitions

In describing and claiming the present invention, the following terminology will be used in accordance with the definitions set forth below.

As used herein, “agglomeration drum” refers to a revolving drum containing oleophilic surfaces that is used to increase the particle size of bitumen in oil sand slurries prior to separation. Bitumen particles flowing through the drum come in contact with the oleophilic surfaces and adhere thereto to form a layer of bitumen of increasing thickness until the layer becomes so large that shear from the flowing slurry and from the revolution of the drum causes a portion of the bitumen layer to slough off, resulting in bitumen particles that are much larger than the original bitumen particles of the slurry.

As used herein, “bitumen” refers to a viscous hydrocarbon, including maltenes and asphaltenes, that is found in oil sands ore interstitially between the sand grains. In a typical oil sands plant, there are many different streams that may contain bitumen.

As used herein, “central location” refers to a location that is not at the periphery, introductory, or exit areas. In the case of a pipe, a central location is a location that is neither at the beginning of the pipe nor the end point of the pipe and is sufficiently remote from either end to achieve a desired effect, e.g. washing, disruption of agglomerated materials, etc.

As used herein, “conditioning” in reference to mined oil sand is consistent with conventional usage and refers to mixing a mined oil sand with water, air and caustic soda to produce a warm or hot slurry of oversize material, coarse sand, silt, clay and aerated bitumen suitable for recovering bitumen froth from said slurry by means of froth flotation. Such mixing can be done in a conditioning drum or tumbler or, alternatively the mixing can be done as it enters into a slurry pipeline and/or while in transport in the slurry pipeline. Conditioning aerates the bitumen for subsequent recovery in separation vessels, e.g. by flotation. Likewise, referring to a composition as “conditioned” indicates that the composition has been subjected to conditioning.

As used herein, the term “confined” refers to a state of substantial enclosure. A path of fluid may be confined if the path is, e.g., walled or blocked on a plurality of sides, such that there is an inlet and an outlet and direction of the flow which is directed by the shape and direction of the confining material. Although typically provided by a pipe, baffles or other features can also create a confined path.

As used herein, the term “cylindrical” indicates a generally elongated shape having a substantially circular cross-section. Therefore, cylindrical includes cylinders, conical shapes, and combinations thereof. The elongated shape has a length referred herein to as a depth calculated from one of two points—the open vessel inlet, or the defined top or side wall nearest the open vessel inlet.

As used herein, “disengagement” and “digesting” of bitumen are used interchangeably, and refer to a primarily physical separation of bitumen from sand or other particulates in mined oil sand slurry. Disengagement of bitumen from oil sands occurs when physical forces acting on the oil sand slurry results in the at least partial segregation of bitumen from sand particles in an aqueous medium. Such disengagement is intended to be an alternative approach to conventional conditioning, although disengagement could optionally be performed in conjunction with conditioning.

As used herein, the “isoelectric point” of a slurry or its clay fines component is the point at which the electric charges on the double layer surrounding clay particles are close to zero, e.g. substantially zero, or are zero. The isoelectric point can be determined by measuring the zeta potential of the clay fines in suspension and also is indicated to some degree by the viscosity of the slurry. Close to the isoelectric point the slurry generally has a higher viscosity than further away from the isoelectric point since electric charges generally disperse the clay fines and the absence of electric charges generally discourages dispersion of the clay fines. Dispersion of the fines commonly is achieved by increasing the pH of the slurry above the isoelectric point or decreasing the pH of the slurry below the isoelectric point.

As used herein, “endless cable belt” when used in reference to separations processing refers to an endless cable that is wrapped around two or more drums and/or rollers a multitude of times to form an endless belt having spaced cables. Movement of the endless cable belt can be facilitated by at least two guide rollers or guides that prevent the cable from rolling off an edge of the drum or roller and guide the cable back onto a drum or roller. The apertures in the endless belt are the slits or gaps between sequential wraps. The endless cable can be a wire rope, a plastic rope, a metal cable, a single wire, compound filament (e.g. sea-island) or a monofilament which is spliced together to form a continuous loop, e.g. by splicing. As a general guideline, the diameter of the endless cable can be as large as 2 cm and as small as 0.001 cm, although other sizes might be suitable for some applications. An oleophilic endless cable belt is an endless cable belt made from a material that is oleophilic under the conditions at which it operates.

As used herein, “fluid” refers to flowable matter. Fluids, as used in the present invention typically include a liquid or gas, and may optionally further include amounts of solids and/or gases dispersed therein. As such, fluid specifically includes slurries (liquid with solid particulate), aerated liquids, and combinations of the two fluids. In describing certain embodiments, the term slurry and fluid may be interchangeable, unless explicitly stated to the contrary.

As used herein, “helical” refers to a shape which conforms to a spiral or twisted configuration where multiple, generally circular, loops are oriented along a central axis substantially perpendicular to a plane of the loops. A helical shape is commonly seen in springs where consecutive loops are stretched along the central axis, although a compacted helical path, i.e. a flat spiral, and the like can also be suitable. Further, the cross-sectional shape can deviate from regular circular and/or can have a constant curvature. For example, a helical shape can have an elliptical cross-section, have a non-constant curvature so as to produce a conical helical shape, and/or can have one or more passes which are skewed or slanted from perpendicular to the central axis. Consistent with this definition, a “helical path” is a path which follows a helical shape and is generally “confined” to such a path by physical barriers such as pipe walls. Such helical shape can include a coil shape, wherein the shape most represents a stretched spring. Alternatively, the helical shape can include a planar helical shape, known as a spiral, wherein the path is of a single plane and is a curve which emanates from a central point, getting progressively farther away as it revolves around the point. In terms of flow path, the flow gets progressively closer to the central point.

As used herein, the term “metallic” refers to both metals and metalloids. Metals include those compounds typically considered metals found within the transition metals, alkali and alkali earth metals. Non-limiting examples of metals are Ag, Au, Cu, Al, and Fe. In one aspect, suitable metals can be main group and transition metals. Metalloids include specifically Si, B, Ge, Sb, As, and Te, among others. Metallic materials also include alloys or mixtures that include metallic materials. Such alloys or mixtures may further include additional additives.

As used herein, “open cylindrical vessel” refers to a vessel which is substantially free of internal structures and/or obstructions other than those explicitly identified as present, e.g. a vortex finder. An open cylindrical vessel can often be a completely vacant cylindrical vessel having various inlets and outlets as identified with substantially no other structures present within the vessel other than an optional vortex finder.

As used herein, “overflow” refers to a more central portion of a swirl flow, and as such, is often the more valuable fluid containing fines and bitumen. “Underflow” likewise refers to a more circumferential portion of a swirl flow and typically contains coarser material and is often drawn off as effluent and/or for further processing. Often, a processed fluid is split into a single overflow and single underflow, although multiple overflow and/or underflows may be useful.

As used herein, “series” represents a number of more than two. A series of nozzles, for example, can be three nozzles, four nozzles, five nozzles, etc. The series of nozzles can be regularly placed or irregularly placed, with respect to distance between nozzles.

As used herein, “operatively associated with” refers to any functional association which allows the identified components to function consistent their intended purpose. For example, units such as pumps, pipes, vessels, tanks, etc. can be operatively associated by direct connection to one another or via an intermediate connection such as a pipe or other member. Typically, in the context of the present invention, the units or other members can be operatively associated by fluid communication amongst two or more units or devices.

As used herein, “periodically crosses” refers to a regular crossing or traversing of particles at periodic intervals (i.e. regular or irregular, but repeating) across the bulk flow of a flowing fluid.

As used herein, the term “hydrocyclone” is used interchangeably with “separating apparatus,” where both terms indicate the equipment, as described herein, beginning with the helical confined conduit and including the open vessel with an underflow and an overflow.

As used herein, “repeating sinusoidal wave in a two-dimensional plane” refers to a shape that, when viewed from a projected side view, has the characteristics of a repeating harmonic wave, i.e. a sinusoidal wave. As such, the sinusoidal wave may in some cases be defined or described in terms associated with sine waves. A repeating sinusoidal wave, according to the present invention, has amplitude and periods. The sinusoidal wave can be deformed, can have delays in period, and can be dampened in all or some of the length of the wave. The pipe in the shape of the wave is not necessarily in a two-dimensional plane of motion. In a specific embodiment, the sinusoidal pipe is substantially two-dimensional and can be described as serpentine. Alternatively, the sinusoidal pipe can have three-dimensional aspects such that at least a portion of the path is out of plane. However, the sinusoidal wave of the present invention is distinct from helical or spiral shapes in that that repeating sinusoidal wave has a velocity directional vector that alternates, whereas spiral and helical shapes are subject to velocity directional vectors that are rotational-based and relatively constant about an axis of rotation. Specifically, repeating sinusoidal waves according to the present invention do not have identifiable axes of rotation parallel to the length of the pipe for longer than one period of repetition of the sine wave shape. At times, and for ease of discussion, the term “repeating sinusoidal wave in a two-dimensional plane” may be shortened to “sinusoidal wave.”

As used herein, “swirl path” refers to a flow pattern which generally follows an unconfined helical path, although significant mixing and chaotic flow occurs along the axis of overall flow down the length of a vessel. A swirl path is generally produced by introducing fluids tangentially into a generally cylindrical vessel thus producing flow circumferentially as well as longitudinally down the vessel length. Although a helical path and swirl path have similar general shapes, a helical path is generally used herein in reference to a confined helical flow while a swirl path refers to an unconfined, generally helical, swirl flow.

As used herein, “velocity” is used consistent with a physics-based definition; specifically, velocity is speed having a particular direction. As such, the magnitude of velocity is speed. Velocity further includes a direction. When the velocity component is said to alter, that indicates that the bulk directional vector of velocity acting on an object in the fluid stream (liquid particle, solid particle, etc.) is not constant. Spiraling or helical flow patterns are specifically defined to have substantially constant or gradually changing bulk directional velocity.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “vortex finder” refers to a centrally located pipe within a hydrocyclone for the purpose of removing overflow from the hydrocyclone. The vortex finder can be a simple pipe having an unrestricted open pipe entrance and, alternately may be provided with a flange at the pipe entrance as well, to encourage overflow to find its way from the hydrocyclone interior into the vortex finder opening.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 cm to about 5 cm” should be interpreted to include not only the explicitly recited values of about 1 cm to about 5 cm, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described. Consistent with this principle the term “about” further includes “exactly” unless otherwise stated.

### Embodiments of the Invention

It has been found that fluids having components of different densities and/or containing different particle sizes, particularly those including particulate and liquid, can be effectively separated using a hydrocyclone having a helical confined path immediately upstream of a substantially open cylindrical vessel. Hydrocyclones of the present invention can be used as a separating mechanism for a variety of fluids. However, the hydrocyclones of the present invention can be particularly suited to de-sanding bitumen-containing aqueous fluids such as those having sand and/or gravel in a slurry of water, bitumen and solids. In one aspect, small bubbles of gas are introduced into the bitumen-containing slurry to better separate bitumen from the particulate. The entrained gas or air can attach to the bitumen and cause it to become lighter than water and thus will result in more effective transfer of bitumen to the overflow. Further, in another embodiment, the processing of a bitumen-containing fluid through the hydrocyclone can remove about 50 to 90% of particulate in the form of gravel and sand, from the bitumen-containing fluid, although these amounts can vary depending on operating conditions and fluid properties.

In accordance with the above discussion, various embodiments and variations are provided herein which are applicable to each of the apparatus, fluid flow patterns, and methods of separating components of a fluid described herein. Thus, discussion of one specific embodiment is related to and provides support for this discussion in the context of the other related embodiments.

As a general outline, a hydrocyclone can include a substantially open cylindrical vessel with an open vessel inlet. The open vessel inlet can be configured to introduce a fluid tangentially into the open vessel. In a specific embodiment, the open vessel inlet connecting the helical confined path to the open vessel can be configured to introduce the fluid with minimal disturbance in fluid flow. The hydrocyclone can also include a helical confined path connected upstream of the open vessel at the open vessel inlet. An overflow outlet and an underflow outlet can be operatively attached to the open vessel. The underflow outlet can be attached at a location on the open vessel substantially opposite the helical confined path and open vessel inlet. The overflow outlet can terminate, on one end, at a vortex finder positioned in an interior of the open cylindrical vessel. The overflow outlet can further include a substantially enclosed conduit from the vortex finder to an exterior of the open cylindrical vessel.

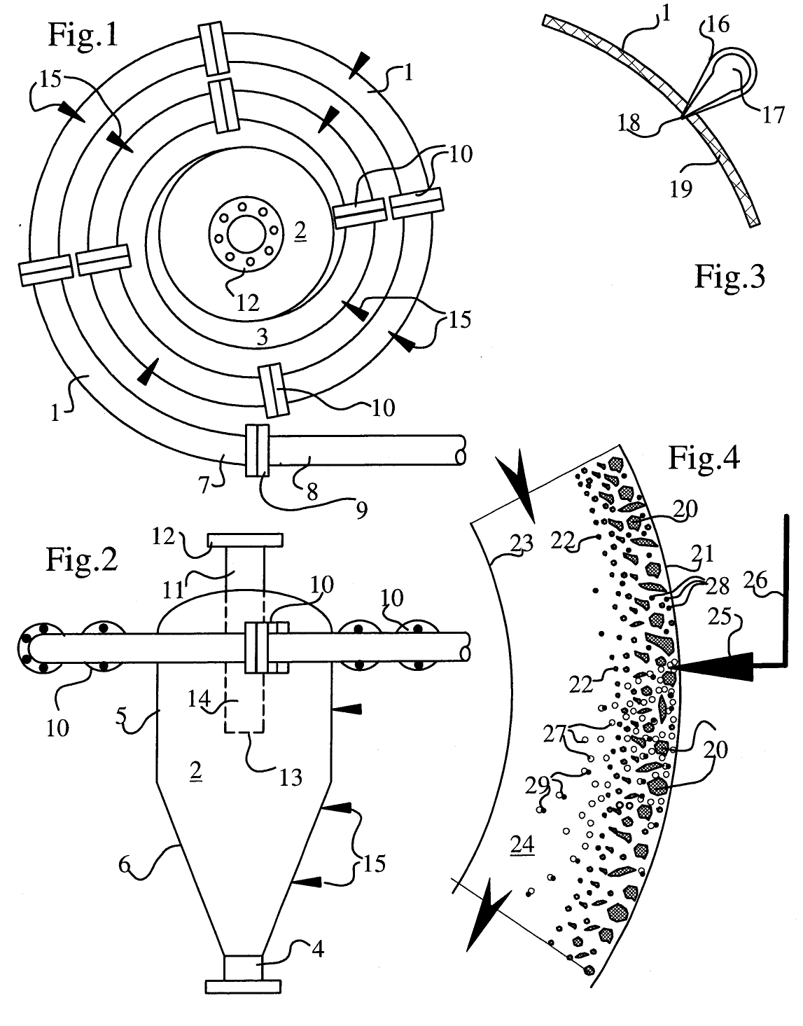

One embodiment of a separating apparatus in accordance with the present invention is shown in FIG. 1 in a top plan view and in FIG. 2 in side view. The separating apparatus can include a helical confined path 1 connected to a substantially open cylindrical vessel 2 at an open vessel inlet 3 which smoothly and gradually connects to the cylindrical portion 5 of the open vessel 2. Such smooth connection allows for introduction of the slurry with minimal disturbance in fluid flow. The separating apparatus can further include an underflow outlet 4 attached to a coned section 6 of the open vessel 2. In the case of FIG. 1, the helical confined path is in the form of a spiral that is connected at its entrance 7 to a straight supply pipe 8 with a flange 9. Additional flanges 10 are shown in the drawings for simplicity to be able to follow the path of the helical confined path.

As shown in FIG. 2, the separating apparatus can further include an overflow outlet 11 attached to the open vessel 2 and ends with a flange 12 to allow for connection to an overflow pipe (not shown). The overflow 14 originates within the open vessel 2 with a vortex finder 13 and ends with the outlet flange 12. Part of the overflow, which is shown with dashed lines, is located within the open vessel 2. The vortex finder 13 can be positioned centrally within the open vessel 2. The length of the overflow pipe 14 with its vortex finder and can be fabricated to allow the location of the vortex finder 13 at a most suitable depth in the open vessel 2 to maximize the efficient removal of overflow. The depth of the vortex finder 13 within the open vessel 2 is optimized by trial and error or by fluid flow calculations for the type of mixture to be separated by the separating apparatus or hydrocyclone.

In accordance with the present invention, a gas can be injected through a series of nozzles along the helical conduit. A series of small nozzles are shown in FIG. 1 and FIG. 2 as pointed arrows 15 which are used to inject a stream of small gas bubbles into the outer flow path of the helical confined conduit 1 and of the open vessel 2. An example of a small nozzle 16 is shown schematically in FIG. 3 including a flow supply pipe 17 for the source of the gas, and a tiny gas nozzle outlet 18 that passes through the wall 19 of the helical confined conduit 1 to become a gas inlet to the conduit or to the open vessel along the outer peripheral walls. Similarly, the nozzle can be mounted on the wall of the open vessel, and be configured to inject gas through the wall of the open vessel.

The shape of the nozzle outlet 18 can be designed to achieve a high gas velocity for the gas entering through the wall of the conduit or of the open vessel. The aperture size of the outlet 18 can be designed or adjusted to produce a desired bubble size and to significantly increase contact area between the gas bubbles and slurry particles. More specifically, a jet of gas passing through a small nozzle at high velocity and entering a liquid stream along the outer periphery has a tendency to break up into a large number of very small gas bubbles, especially when impacting on solids in the liquid stream. When these gas bubbles encounter bitumen droplets trapped between coarse solids in the stream, these small bubbles have a tendency to cling to the bitumen droplets and cause them to assume a bulk density that is much lower than the bulk density of the stream of water and coarse solids flowing along the outer periphery of the helical confined conduit or along the periphery of the outer wall of the open vessel. Centripetal forces acting on the flowing liquid in the confined helical conduit or in the open vessel then force the bitumen droplets away from the outer wall of the helical confined conduit 1 due to their reduced bulk density in view of one or more small gas bubbles being attached to each bitumen droplet.

This mechanism of bitumen scavenging is shown in more detail in FIG. 4, which is a simulated internal view of a section of the helical confined conduit 1. Coarse and/or dense solids 20 in a slurry flow along the outer wall 21 of the conduit due to the centripetal forces acting on the liquid flowing in a helical path through the conduit 1. Finer and/or lighter solids 22 in the slurry flow closer to the centre of the conduit and very fine solids (not shown) will tend to flow along the inner periphery 23 of the conduit. The forces that cause this sorting of solids by size or density are the centripetal forces that act on the contained fluid 24 flowing in the curving conduit. A nozzle, illustrated with the arrow 25 and its supply pipe 26 forces a gas into the outer periphery of the flowing stream in the conduit to form small gas bubbles 27 that enter the flowing stream. Small bitumen droplets 28 trapped between the coarse solids 20 attach themselves to gas bubbles upon contact and form bulk density reduced bitumen droplets 29 because of their attachment to the gas bubbles. Centripetal forces acting on the fluid of the flowing stream force the bulk density reduced bitumen droplets to migrate towards the inner periphery 23 of the helical confined conduit and become part of the mixture that eventually reports to the overflow of the separating apparatus. In this manner, bitumen can be scavenged from the voids between the coarse particulates. The remaining bitumen depleted coarse solids in the slurry eventually report to the underflow of the open cylindrical vessel. In this manner, the underflow containing the coarse solids of the oil sand slurry become relatively bitumen free and the overflow will contain most of the bitumen particles of the oil sand slurry. This mechanism of bitumen scavenging results in a higher overall bitumen recovery when the overflow is subsequently separated into bitumen, water and solids. Froth flotation can optionally be practiced on this overflow to recover the bitumen, however one aspect of this instant invention is for the recovery of bitumen by an oleophilic endless cable screen, as per the Kruyer process and/or in accordance with the previously noted related patent applications.

A spiral helical confined conduit was chosen for the illustration of FIG. 1 and FIG. 2 since it lends itself particularly well for the smooth flow of a slurry in a helical conduit. When a serpentine pipe is used for the preparing of a slurry to disengage bitumen from the oil sand grains, the slurry undergoes very high mixing and shearing forces in order to produce a well digested slurry. For a detailed description of the design and operation of a serpentine pipe, see U.S. patent application Ser. No. 11/939,978 filed Nov. 14, 2007 entitled: “Sinusoidal Mixing and Shearing Apparatus and Associated Methods” which is incorporated herein by reference. Although beneficial in digestion of the slurry, a slurry exposed to these high mixing and shearing forces may also have a tendency to cause the emulsification of some of the bitumen particles with water in the aqueous phase of the slurry. In order to at least partly break this emulsion, a period of quiescence can allow the bitumen particles to de-emulsify. A long, large diameter, straight pipe between the serpentine pipe and the hydrocyclone can be beneficial for providing such a period of quiescence in the flowing slurry. The specific length can vary depending on the flow rates, degree of emulsification, and other similar factors. Using a helical confined conduit in the form of a spiral has the additional advantage of gradually increasing the centripetal force on the flowing slurry in the conduit while keeping the slurry in state of relative quiescence. A spiral is characterized by a gradually increasing rate of curvature. For a slurry flowing through such a conduit at a velocity that is constant throughout the conduit, the centripetal force on the flowing slurry gradually increases and can become very high as the slurry moves towards the vessel. The centripetal forces of a slurry flowing through a helical confined conduit in the form of a spiral is the gradual movement of solids towards the outer wall. It should be noted that typically, a helical confined conduit has a circular or otherwise rounded cross-section, and the outer wall and inner wall are not necessarily planar walls, but are specific regions of the helical confined conduit. For example, the curvature of the helical confined conduit, at any point along the length, forms an arc that has a focus point. The outer wall is that region of the helical confined conduit that is farthest from the focus point, whereas the inner wall is that region of the helical confined conduit that is nearest the focus point.

The centripetal forces of a slurry flowing through a helical confined conduit has the gradual movement of solids towards the outer wall with minimal disturbance of the flowing slurry. The coarse and heavy solids initially move to the outer wall, when the centripetal forces are relatively small, and then gradually, as the centripetal forces increase, this layer of solids increases in thickness as the smaller and lighter solids progressively deposit onto the coarse solids and into the voids between the coarse solids. In this manner, a relatively smooth transitional sorting of the solids takes place while the slurry is flowing through the helical confined conduit. After the slurry arrives in the open vessel, with a transition having low disturbance in fluid flow, the bed of coarse solids can continue to flow along the outer periphery of the open vessel and report to the underflow while the coarse solids depleted slurry reports to the overflow with most of the bitumen from the initial slurry.

The nozzles that supply gas to the helical confined conduit serve to introduce gas bubbles that effectively scavenge bitumen droplets out of the voids in the bed of flowing solids flowing along the outer wall of the conduit and helps in transferring these to the stream that eventually leave the hydrocyclone through the overflow. While this discussion mainly centered around the benefits of a helical confined conduit in the form of a spiral, a similar transfer of captured bitumen droplets takes place with the help of gas bubbles if these are introduced in a helical confined path in the form of a coil.

The nozzles can be present in a series along the length of the helical confined coil. The series can be regularly or irregularly spaced. Typically, a nozzle can be mounted at a location along the outer wall of the helical confined conduit. A variety of nozzles can be used in the design of the separating apparatus. In one aspect, the series of nozzles can be designed for sonic gas flow through the nozzles, where each nozzle is configured to produce local cavitation and gas dispersion upon the gas entry into the helical confined conduit

Gas bubbles may be produced in various sizes by the use of a nozzle impacting on a liquid. Small size gas bubbles are preferred for these have a lower tendency to coalesce. A high concentration of very small bubbles sweeping through the voids between coarse particles near the outer wall of the confined helical path has a greater opportunity to dislodge bitumen from the voids than the same amount of gas in the form of larger bubbles. Generally, bubbles can have diameters smaller than about 3 mm, although bubbles having a diameter smaller than about 0.3 mm or even about 0.03 mm can be particularly useful in achieving increased contact surface area with any trapped bitumen. While such small bubbles can be desirable there are practical limitations in the amount of energy that conveniently can be expended for bubble formation and bubble size reduction. Another method of producing very small and well dispersed bubbles is to prepare a liquid, such as, water and gas mixture under high pressure in a vessel which is then allowed to flow through the nozzles. Under high pressure, gasses such as air, air enriched by oxygen, methane, ethane, propane, carbon dioxide, or combinations thereof may be dissolved in large quantities in liquid, such as water, under high pressure. When such high pressure liquid and dissolved gasses flow through the nozzles of the instant invention and encounter an environment of lower pressure in the helical confined conduit, the gasses are released in the form of small bubbles. When the high pressure liquid of the instant invention encounters the flowing stream of liquid and particles in the helical confined conduit, many small bubbles of gas are released very quickly and sweep through the voids between the slurry solids to transport trapped bitumen out of the voids between the coarse solids.

Therefore, as outlined above, the instant invention can function to scavenge bitumen droplets out of the voids between coarse particulates in an oil sand slurry that report to the underflow of an open vessel of a separating apparatus. The scavenging can be accomplished by means of small gas bubbles produced by jets mounted in the outside curved wall of a helical confined conduit of a separating apparatus. In this scavenging apparatus and method, bitumen droplets that are trapped in the voids between coarse particulates are released by the action of the gas bubbles which, by adhesion to the bitumen droplets cause the bitumen droplets become lighter and flow out of the voids due to centripetal forces in the fluid flowing through the helical confined conduit.

The gas used is a gas under pressure flowing through the nozzles and may contain air, oxygen enriched air, a light hydrocarbon gas, such as methane, ethane, propane, butane, carbon dioxide, or any combination thereof. The use of carbon dioxide may also serve to neutralize an oil sand slurry if it has a pH greater than 7. A neutral pH of about 7 can be used for isoelectric separation of oil sands to minimize the dispersion of tailings fines produced during the subsequent recovery of bitumen from the hydrocyclone overflow.

Optionally, one or more nozzle can be mounted along the wall of the open vessel. Such nozzles can be configured to inject a gas, a liquid including dissolved gas, or even washing fluid.

The helical confined conduit situated upstream of the open vessel can be configured to cause a fluid to at least partially separate, or begin the separation process prior to entering the open vessel. Additionally, the helical confined path can cause the fluid to travel in a path that encourages further separation and easier transition once introduced into the open vessel. As such, parameters such as the size and configuration of the helical confined conduit, the number and location of nozzles, the dimensions of the open vessel, and the open vessel inlet can affect processing. The number of rotations of the helical confined path can, for some fluids, allow for a shorter or longer time spent in the open vessel to produce the same level of separation. In a specific embodiment, the helical confined path can wind for about 1 to about 10 full rotations. In a further embodiment, the helical confined path can wind for about 2 to about 5 full rotations.

The open vessel inlet, which introduces fluid from the helical confined conduit into the open cylindrical vessel, can be configured to introduce the fluid with minimal disturbance in the fluid flow. For example, the internal surfaces at the connection between the helical flow conduit and the open vessel can be a substantially smooth transition where the outer diameter of the helical flow path blends into the inner surface contours of the open vessel. In one embodiment, the outer diameter of the helical flow conduit can be substantially identical to the inner diameter of the open vessel. The fluid exiting the helical flow path can flow in a swirl flow path within the open vessel that initially is similar to the flow path in the helical pipe. Minimal disturbance in the fluid flow from the helical confined conduit to the open vessel allows for greater separation efficiency. This configuration further reduces abrasive wear on internal surfaces of the open vessel. In particular, initiating the swirl flow well ahead of introduction into the open vessel can significantly reduce wear and abrasion of the open vessel internal walls. The slower flowing bed of solids flowing along the outer wall of the helical confined conduit will flow into the open vessel at a slower rate than non-peripheral flow of the fluid. This aspect of the present invention provides wear reduction as compared with direct tangential introduction of a slurry into an open vessel where the swirl is established only after the slurry enters the open vessel.

To aid in fluid flow, in one embodiment, a pump or a plurality of pumps can be used. This is particularly useful at the beginning of the helical confined conduit to cause the fluid to flow at a desired velocity which is generally relatively high. Normally a pipe or pipeline provides the slurry to the helical path but pumps can optionally be additionally used. However, care in design should be taken in order to prevent or reduce undesirable disturbance to flow patterns of the incoming slurries.

In one aspect, the helical confined conduit can be a pipe. In one aspect, such pipe can be configured in a coil symmetrically wound at a constant curvature or at progressively increasing tight curvature. In another embodiment, the pipe can be configured in a spiral configuration, as illustrated in FIG. 1 and FIG. 2. In configurations using a pipe as at least a portion of the helical confined conduit, the pipe can include a plurality of pipe sections. In one aspect, one or a plurality of the pipe sections can be an elbow. In one design, more than one elbow can be used together to form the desired curvature of the helical confined path. In embodiments that include a plurality of elbows, the elbows can be substantially the same angle, or can include a plurality of different angles. In one aspect, and as illustrated in FIG. 1 and FIG. 2, the pipe sections can be attached at flanged joints. This segmented helical path can facilitate cleaning, replacement, and other maintenance.

In another embodiment, the helical confined conduit can be formed without pipe sections such as elbows. For example, a single length of pipe, tubing, or other confining-material can be created or formed to the desired helical shape. In the case of a pipe, such shape can be achieved by conventional pipe bending equipment or other suitable pipe shaping techniques. In the case of tubing or other readily movable material, the tubing can be wound into the desired shape and secured. These embodiments can be relatively inexpensive to make and install, but may also reduce access to internal sections for cleaning and/or maintenance.

One benefit of using a plurality of pipe sections to construct the helical confined conduit is that repair and replacement is relatively easy. For example, if a segment of the pipe needs replacing, it is a much simpler process to remove and replace the individual pipe section than to replace the entire pipe. Furthermore, as some maintenance of the pipe may require access to the inner channel of the pipe, it is generally simpler to detach or remove a pipe section, and thus have access to the inner area of the pipe, rather than insert tools and equipment down the length of the pipe, or to cut into a single pipe. In embodiments that include a plurality of pipe sections, the sections can be attached in any fashion that maintains that connection during normal use for the desired use time. However, care should be taken to maintain the same curvature at and near the joints as the curvature in the pipe sections in order to prevent the creation of disturbances in the flow. In a specific embodiment, at least one of the attachments can be attachment by a flanged joint. Spacing flanged joints, as opposed to welded joints, periodically along the length of the helical confined path allows for ease of repair of the sections. Additionally, using flanged joints can allow for repair, maintenance, or treating the inner surface of the pipe. Further, relatively short flanged sections can be preferred in some embodiments, as they allow for easier repairs and/or maintenance as opposed to larger sections attached by flanged joints. Although flanged joints are discussed in conjunction to pipes, it should be noted that various optionally detachable joints can be used with a variety of materials used to create the helical confined path. When optionally detachable joints are used, the same or similar benefits can be realized as with flanged pipe joints, i.e. ease in access to inside the confined path, ease in repair, maintenance, etc.

One benefit of flanged joints, although not required, is in treating the inner surface of the helical confined conduit, e.g. pipe, and/or the open vessel. Some fluids can include large particulate solids, and even abrasive particulate, which can wear or otherwise alter at least part of the inner surface of the helical confined conduit and/or open vessel. Some fluids can affect the inner surfaces in other ways, such as corrosion and/or erosion. As such, it can be useful to provide additional wearing surfaces, particularly in the case of particulate solids in the fluid, and to reinforce such wearing surfaces to extend the working life of the surface, and thus the hydrocyclone. Wearing surfaces can include, but are not limited to, alloy hard surfacing, ceramic coating, or the like. Flanges are not required for the instant invention but can be preferred in some embodiments, since short flanged sections of the helical confined path and/or open vessel allow repair of each section after it has been abraded for a while by coarse solids flowing through the hydrocyclone. The use of flanges also makes it more convenient to hard plate, e.g. chrome plate, the inside of these sections individually to make it more wear resistant, or to hard surface the inside of a at least a portion of each section in those areas where the inside surface is impacted by colliding solids. Hard surfacing may be done by bead welding, overlay welding, boriding, ceramic deposition, build up, cladding, or by other suitable means. Such surfacing can be uniform or patterned, e.g. herringbone, dot, bead strings, waffle, etc. Rough surfaces on the helical confined path inside wall may create undesirable disturbance in the flowing liquid or may create desirable erratic movement of solids flowing along the wall to help dislodge trapped bitumen particles. Therefore, patterns welded on the inside wall of the helical confined conduit need to be placed carefully in those areas impacted mostly by the flowing solids in the conduit an in the open vessel.

Analysis of fluid flow, taking into consideration the composition of the fluid and the shape of the hydrocyclone, can indicate the potential wearing surfaces that will experience the most wear. For processing fluids with particulate solids, the wearing surfaces of the helical confined conduit may include the surfaces of the helical confined conduit on the more circumferential point of the helical conduit. As particulate solids may, in some cases, have a greater density (or have larger particle sizes), the circumferential action on the fluid traveling through the pipe will cause the particulate solids to migrate towards the portion of the path that is furthest from a central axis of the helical conduit. The fluid in the open vessel experiences similar forces, and the majority of the inner surface of the open vessel, depending on flow path, can experience abrasive erosion. These areas are more likely to experience abrasive erosion than more inside sections, i.e. sections closer to the central axis of the helical path. In the cases of corrosive and/or erosive materials, the wearing surface may include a majority of the inner surface of the open vessel and/or the helical confined conduit. As such, in one embodiment, at least a portion of an inner surface of the open vessel and/or the helical confined conduit can be reinforced as a wearing surface. In a further embodiment, a majority of the inner surface of the open vessel and/or the helical confined conduit can be reinforced as a wearing surface.

In one embodiment, plating material onto the surface can reinforce the inner surface of open vessel and/or the helical confined conduit. The plated material preferably has a greater hardness than the hydrocyclone surface, or is more resistant, chemical or otherwise, to fluid action on the surface than the untreated inner surface. One of the materials used to plate the inner surface of an open vessel and/or a helical confined conduit can comprise or consist essentially of chrome, silicon carbide, titanium carbide or other hard materials suitable for plating or attachment to steel surfaces. Another manner of reinforcing a wearing surface can include hard surfacing the inner surface with welding tracks or beads. Other methods of reinforcing a wearing surface can include surface treatments, such as forming one or more films on the surface, and roughing or smoothing the surface. In a specific embodiment, at least a portion of an inner surface of the open vessel and/or the helical confined conduit includes an anti-corrosive material, for example rubber coating, urethane coating or epoxy coating.

In another embodiment, the helical confined conduit can be formed by wrapping a flexible hose into the shape of a coil or spiral that attaches to the open vessel inlet at the hose outlet and attaches to a pipe, pipeline or pump at the hose inlet. The hose can be made from any suitable flexible material such as, but not limited to, rubber, urethane or other durable and wear and abrasion resistant flexible material. The flexible hose can be reinforced internally in the hose walls, for example with steel mesh or steel wire. Such a hose may be relatively inexpensive to form into a helix or a spiral and will be easy to replace when worn out. The hose can be readily wrapped on a mandrel to keep it in shape or it could be fabricated to retain the form of a coil or spiral. The hose may be wrapped or fabricated to form a coil, a spiral in one plane or a spiral that assumes the outline of a cone as described previously.

In one aspect, the open vessel can have a diameter that remains substantially uniform from the connection of the helical confined conduit to the depth of the vortex finder. In this case, the noted portion of the open vessel has the shape of a cylinder. In a further embodiment, the diameter of the open vessel can decrease from the depth of the vortex finder to the underflow outlet so as to form a conical reduction when the hydrocyclone is configured for counter-current flow of the underflow with respect to the overflow.

Another factor to consider in creating or forming a hydrocyclone is the material used to form the vessel and/or helical conduit walls. Standard materials can be used in the present invention. Non-limiting examples include ceramic, metal and plastic or internal covering of metal walls with ceramic, epoxy, plastic, rubber or other abrasion resistant materials. In a preferred embodiment, the hydrocyclone includes a metallic material. In a more specific embodiment, the vessel and helical confined conduit of the separating apparatus can comprise or consist essentially of iron or its alloys such as steel, or steel that is coated with an abrasion resistant metal by means of plating or welding.

In a specific embodiment, a method for separating components from a bitumen-including slurry can include guiding the slurry along a helical path at a high velocity to form a helically flowing slurry. The method can further include tangentially injecting the helically flowing slurry into an open vessel such that the slurry rotates along a swirl path within the open vessel. The slurry rotation in the swirl path, and enhanced by rotation in the helical path, can be sufficient to produce an overflow and an underflow. Such slurry separation is based on the varying densities and varying particle sizes of the components of the slurry. The method can additionally include injecting a gas into the flow of slurry of the helical path and optionally of the swirl path. The overflow and underflow can be removed from the open vessel.

The fluid in the helical path can travel at any velocity sufficient to produce, along with the presence of small gas bubbles, an initial separation of the slurry components while in the helical path and/or produce an overflow and underflow while in the open vessel. Such initial separation can include compositional differences across a diameter of flow. Although such velocity will vary depending on the design of the hydrocyclone and the fluid to be processed, in one embodiment, the magnitude of the velocity of the fluid in the helical path can be from about 1 meter per second to about 10 meters per second, and in some cases from about 2 meters per second to about 4 meters per second.

The overflow and underflow will generally contain particulates but will have different compositions. The overflow will contain, ideally, water and bitumen and sand, silt and clay particulates which are smaller and possibly with lower density. The underflow, on the other hand, will ideally contain water, silt, sand, and particulates which are larger and possibly having a higher density. As noted, the fluid to be separated can be a slurry containing particulates. In such case, and depending on the other components in the slurry, the underflow can include particulates. The hydrocyclones of the present invention are particularly suited to separation of an oil sand slurry which is a continuous water phase containing dispersed bitumen particulates or agglomerates, gravel, sand, silt and clay or a water suspension of dispersed bitumen product and fines. One specific use of the hydrocyclone can be in de-sanding fluids containing bitumen. In such case, the fluid can include particulates, bitumen, air and water. Particulates included in the bitumen-containing fluid can include gravel, sand, and fines. When processed, the overflow can include the majority of the bitumen of the fluid and the underflow can include the majority of the gravel and sand.

Not all bitumen-containing fluids are the same, and the varying properties of the bitumen-containing fluid can be considered when designing a particular hydrocyclone. Conditions and/or design of the hydrocyclone can be specifically configured for improved and optimum processing. In a specific embodiment, the helical confined conduit and/or open vessel can be designed and shaped based on compositional and physical properties of the fluid. Therefore, parameters may be adjusted for varying types of bitumen-containing fluids. In one aspect, the bitumen-containing fluid can be a result of pre-conditioning of oil sands and water. As such, the composition of the fluid can, at least partially, depend on the composition of the oil sands. Some oil sands contain a high percentage of bitumen and low percentage of fines, while other oil sands contain moderate or a small percentage of bitumen and further have a high fines content. Some oil sands come from a marine deposit and other oil sands come from a delta deposit, each having different characteristics. Some oil sands are chemically neutral by nature and other oil sands contain salts and other chemicals that affect, among other things, the pH or the salinity of the slurry.

Other factors to consider when dealing with oil sands include the composition of the rocks and gravel, and lumps of clay in the oil sand after crushing. Not only the size of the rocks, gravel and clay lumps but also the percentage of these in the crushed oil sand, as well as the shape of the rocks gravel or lumps of clay can affect processing conditions. Likewise, the chemical composition of the slurry as it is being processed by the hydrocyclone can affect processing. For example, a fluid that has a low pH or a high pH inherently, or by the addition of chemicals will have a very different rheological characteristic than a slurry that is close to neutral or close to the isoelectric point. The pH of a fluid can have a substantial impact upon the dispersion of fines in such a fluid and upon the resulting viscosity of the fluid. At high or low pH the clay fines are dispersed, resulting in low viscosity fluids in which bitumen particles and the coarse solids are substantially free to move and/or settle within the fluid.

A factor to consider in selecting processing parameters is the velocity of the fluid as it flows through the hydrocyclone, and helical confined conduit in particular. For a given pump capacity, a different pipe size will result in a different fluid velocity in the hydrocyclone. Therefore, multiple pumps can be used in some embodiments ahead of the helix (rather than in or after the helix which would create undesirable disturbance to the flow path).

Processing time for slurries differs greatly depending on the helical confined path, open cylindrical vessel, slurry composition and properties, desired processing, etc. As a non-limiting example, however, the slurry can have an average residence time in the separating apparatus, from introduction into the helical confined path, until removal as either underflow or overflow of from about 1 second to about 30 seconds, and in some cases from about 4 seconds to about 10 seconds.

Of course, it is to be understood that the above-described arrangements, and specific examples and uses, are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A separating apparatus, comprising:
a helical confined conduit;
a substantially open cylindrical vessel connected downstream of the helical confined conduit, said open vessel having an open vessel inlet configured to introduce a fluid from the helical confined conduit into the open vessel with minimal disturbance in a fluid flow;
an overflow outlet operatively attached to the open vessel such that the overflow outlet terminates on one end at a vortex finder positioned in an interior of the open cylindrical vessel and has a substantially enclosed conduit from the vortex finder to an exterior of the open cylindrical vessel;
an underflow outlet operatively attached to the open vessel at a location on the open vessel substantially opposite the open vessel inlet; and
a series of nozzles operatively connected on the helical confined conduit configured for injection of a gas into an outer flow path of the helical confined conduit, wherein the introduction of gas into the flow path is further configured to form small gas bubbles within the fluid.

2. The separating apparatus of claim 1, wherein the series of nozzles are designed for sonic gas flow through the nozzles and wherein each nozzle is configured to produce local cavitation and gas dispersion upon entry of the gas into the helical confined conduit.

3. The separating apparatus of claim 1, wherein each nozzle of the series of nozzles is configured to inject the gas dissolved in a high pressure liquid, wherein the high pressure liquid is at a pressure that is higher than a pressure of the fluid in the helical confined conduit.

4. The separating apparatus of claim 1, wherein the helical confined conduit is a pipe configured in a coil shape symmetrically wound at a constant curvature.

5. The separating apparatus of claim 1, wherein the helical confined conduit is configured in a spiral shape.

6. The separating apparatus of claim 1, wherein the helical confined conduit is a pipe and at least a portion of an inner surface of the pipe or an inner surface of the open vessel is reinforced as a wearing surface.

7. The separating apparatus of claim 1, wherein the helical confined conduit is a flexible hose.

8. The separating apparatus of claim 1, wherein the helical confined conduit winds from 1 to 10 full rotations.

9. The separating apparatus of claim 8, wherein the helical confined conduit winds from 2 to 5 full rotations.

10. The separating apparatus of claim 1, wherein the open cylindrical vessel has a diameter that remains substantially uniform from the connection of the helical confined path to a depth of the vortex finder.

11. The separating apparatus of claim 10, wherein the diameter of the open cylindrical vessel decreases from approximately the depth of the vortex finder to the underflow outlet.

12. The separating apparatus of claim 1, wherein the overflow outlet is attached to the open vessel at a location substantially opposite the underflow outlet.

13. The separating apparatus of claim 1, wherein the overflow outlet is attached to the open vessel at a location on the open vessel substantially opposite the vessel inlet from the helical confined path, and on substantially a same end as the underflow outlet.

14. The separating apparatus of claim 1, further comprising at least one nozzle operatively connected to a wall of the open vessel, and configured for injection of a fluid.

15. A method for separating a flowing oil-sand slurry into an underflow comprising water and mineral particles, and an overflow comprising water, fine mineral particles, and bitumen, comprising:
guiding the slurry along a helical path at high velocity to form a helically flowing slurry, wherein the helically flowing slurry includes an outer flow path and an inner flow path;
injecting a gas into the helically flowing slurry sufficient to form small gas bubbles in the outer flow path, wherein the gas bubbles scavenge and transfer bitumen particles from the outer flow path to the inner flow path;
tangentially injecting the helically flowing slurry into an open vessel such that the slurry rotates along a swirl path within the open vessel, sufficient to produce an overflow and an underflow; and
removing the overflow and the underflow from the open vessel.

16. The method of claim 15, wherein the gas bubbles comprise a gas selected from the group consisting of air, oxygen-enriched air, carbon dioxide, methane, ethane, propane, butane, and mixtures thereof.

17. The method of claim 15, wherein the gas injected into the helically flowing slurry is gas bubbles dissolved in a high pressure liquid having a pressure greater than a pressure of the helically flowing slurry, whereupon injection of the high pressure liquid into the helically flowing slurry, the high pressure liquid releases dissolved gas in the form of bubbles.

18. The method of claim 17, wherein the gas bubbles comprise a gas selected from the group consisting of air, oxygen enriched air, carbon dioxide, methane, ethane, propane, butane, and mixtures thereof.

19. The method of claim 15, wherein the helical path comprises a spiral shape.

20. The method of claim 15, wherein the helical path comprises a coil shape.

21. The method of claim 15, wherein the slurry includes bitumen, water, sand, and coarse particulates, and wherein the overflow contains a bulk of the bitumen from the slurry and the underflow contains a bulk of the coarse particulates and sand of the slurry.

22. The method of claim 21, further comprising entraining air into the fluid in an amount sufficient to increase bitumen recovery in the overflow and without substantial formation of bitumen froth, said entraining air occurring prior to guiding the fluid in the helical path.

23. The method of claim 21, wherein the overflow includes less than 20% particulate as gravel or sand.

24. The method of claim 15, wherein upon transfer of the bitumen particles from the outer flow path to the inner flow, the gas bubbles dissolve into the slurry.

25. The method of claim 15, wherein the gas bubbles are smaller than about 0.3 mm.
